(19) United States
(12) Patent Application Publication
(10) Pub. No.: US 2019/0118693 A1
(43) Pub. Date: Apr. 25, 2019

(54) MOBILE PARTY SYSTEM

(71) Applicant: Winding River Enterprises, LLC, Wellesly, MA (US)

(72) Inventors: Peter Murphy Vandervelde, SR., Wellesley, MA (US); Nancy T. Vandervelde, Wellesley, MA (US); Peter Murphy Vandervelde, JR., Wellesley, MA (US); John Patrick Vandervelde, Wellesley, MA (US)

(73) Assignee: Winding River Enterprises, LLC

(21) Appl. No.: 16/165,425

(22) Filed: Oct. 19, 2018

Related U.S. Application Data
(60) Provisional application No. 62/574,815, filed on Oct. 20, 2017.

(51) Int. Cl. B60P 3/025; B62D 53/06; B62D 33/04; B60H 1/00

(52) U.S. Cl. CPC B60P 3/0257; B60H 1/00028; B62D 33/042; B62D 53/06

(57) ABSTRACT

A mobile party system based on a standard semi-trailer having an interior wall running side to side dividing its interior space into two equal halves, each such half being a separate party area that can be accessed by party goers through a releaseable, pivotable wall situated within a side panel of said semi-trailer, and each such party area being outfitted with heating, cooling, and ventilation equipment, an electrical power source, at least one restroom, and with kitchen and bar service facilities.

### SUMMARY OF THE INVENTION

The problem to be solved that the instant invention fixes is the lack of on-demand mobile tailgating experiences nationwide. For example, at college and professional football stadia, visiting team fans are unable to enjoy the type of tailgating experience that they might enjoy at their home stadium given that the distances traveled do not allow for transport and use of the tailgate facilities that they use at home, such as outfitted vehicles and associated gas grills, portable bars, and the like. Additionally, at stadia located in less developed and/or remote locations there may be very few tailgating oriented bars or restaurants nearby. This invention also makes tailgating experiences more efficient and accessible while lowering costs. Moreover, these problems are ameliorated by a rental process for the use of the systems described herein.

The current landscape of home-based tailgating, or prior art to this invention, is often very localized (team or stadium specific) and consists mostly of converted tow-trailers (such as Prior Art Figures A and B), RV's (such as Prior Art Figures C and D), old busses, and food trucks. Prior Art Figure A shows a tow-trailer converted so as to have an opening from which food and beverages can be served that is accessible when the cantilevered, pivotable shutter covering the opening is raised, as well as a removable sun, rain, or snow shielding canopy that can be placed over the area of accessibility. Prior Art Figure B similarly shows a tow-trailer converted to have multiple openings from which food and beverages are served to partygoers who gather outside of the trailer. Prior Art Figure C depicts a standard recreational vehicle (RV) that is outfitted with a canopy to protect partygoers who gather outside of the vehicle from sun, rain, and snow. Similarly, Prior Art Figure D shows as well as standard RV to which is attached a protective canopy for partygoers gathered outside of the vehicle. None of these options offer a seating and bathroom configuration that can accommodate 20-40 people intent on partying before the big game or sold out concert. The current landscape of options at away stadia is virtually non-existent and that places a burden on the traveling fan/consumer. The instant invention tractor-trailer design will be a fully equipped with kitchenette, lounge, and bathroom areas. All tailgating suites will have heating and air conditioning therefore civilizing the traveling fans tailgate experience.

The preferred embodiment of the instant invention is shown in the revolutionary trailer/party system configuration as shown of FIG. 1 that will allow for seamless relocation of the system from venue to venue. These mobile tailgating units will be made from converted 53′ by 9′ 9″ tractor trailer frames which have already been approved by U.S Department of Transportation. Currently there are no such tractor trailers that have been converted for this type of use with electrical, HVAC, plumbing, and kitchen/bar service amenities necessary for civilized tailgating functionality.

### BRIEF DESCRIPTION OF THE DRAWINGS

Prior Art Figures A and B are perspective views of converted tow-trailers.

Prior Art Figures C and D are perspective views of recreation vehicles.

FIG. 1 is a floor plan of the system of the present invention.

### DETAILED DESCRIPTION OF THE INVENTION

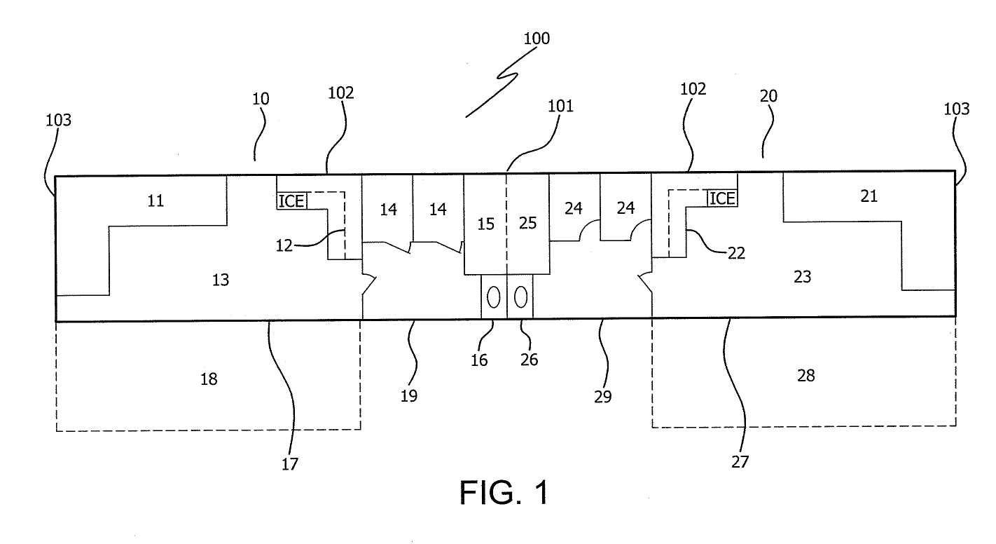

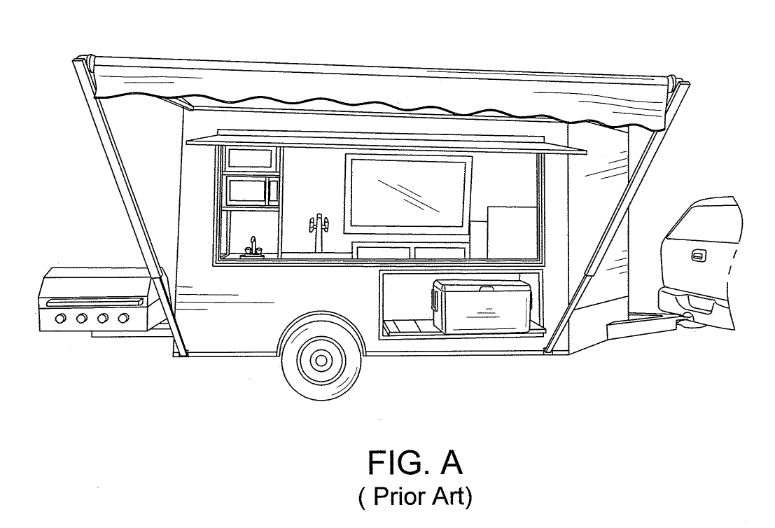

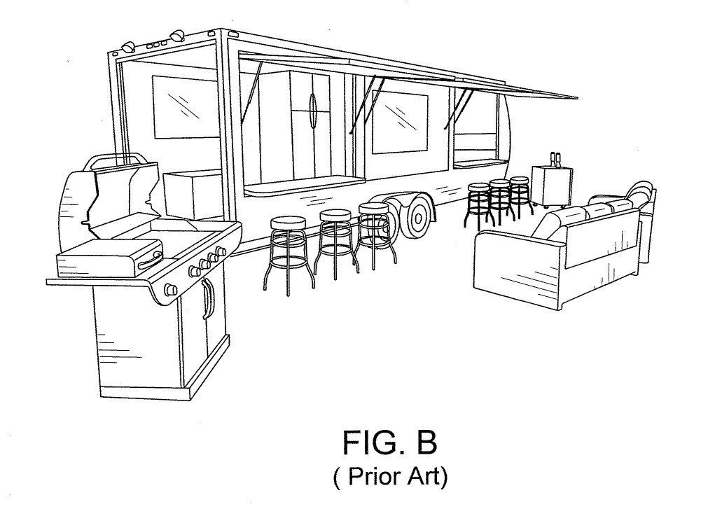

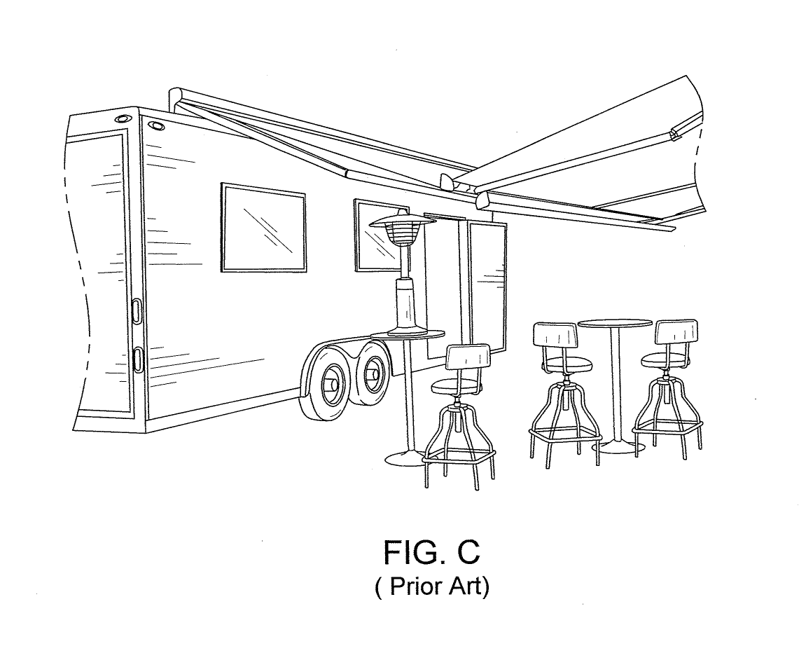

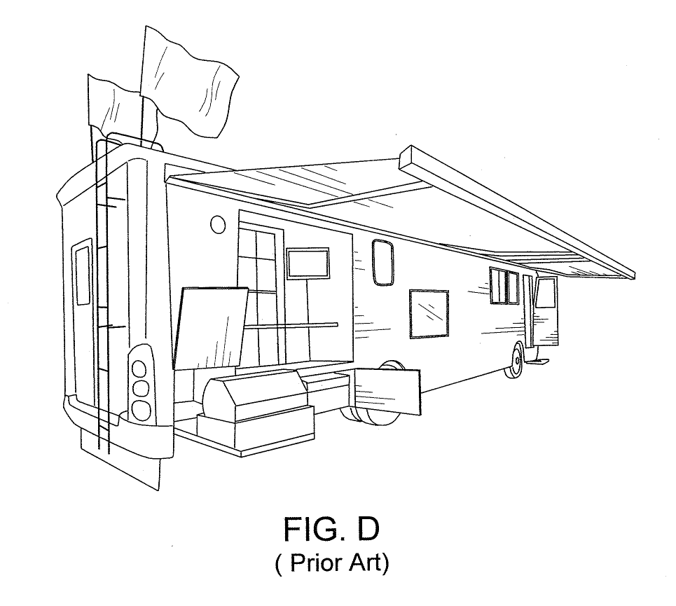

Referring to FIG. 1, the floor plan of mobile party system 100 is depicted as a block diagram based on a 53′ by 9′ 9″ rectangular semi-trailer truck bed with approximate horizontal dimensions shown (in feet) on the top of the floor plan. System 100, a semi-trailer designed to be pulled by a tractor unit, is divided at point 101 into two equally proportioned, equally outfitted interior party areas, interior party area 10 and interior party area 20, that are mirror images of each other. Interior party area 10 is comprised of an L-shaped sitting area 11, counter 12 having kitchen and bar amenities, such as the ice machine shown as an example, open area 13, twin toilet stalls 14, mechanical systems area 15 that houses heating, cooling, and ventilation equipment, and sink area 16. Economies are inherent in this design given that mechanical area 25 for party area 20 shares such HVAC equipment with area 15, thereby servicing two party areas with one set of HVAC equipment. Interior party area 20 similarly is comprised of sitting area 22, counter area 23, twin toilet stalls 24, as well as such area 25.

Access to the interior of tractor trailers in the prior art is limited to opening doors located at the trailing end of the unit. The instant invention is novel in that access to party area 10 is by way of unlocking releasable wall 17 and pivoting wall 17 vertically to a horizontal position that allows access to party area 13 by way of a set of removable steps (not shown). Wall 17 is held in place horizontally by removable posts (not shown) and in such horizontal position provides a tent-like cover for exterior party area 18 which provides for shade and protection from the elements for tailgating activities taking place outside of interior party area 10. Similarly, the mirror image interior party area 20 is accessed by unlocking and pivoting releasable wall 27 in the same manner, creating exterior party area 28, by which tailgaters are protected from sun, rain, and snow. Stationary wall 19 and stationary wall 29 remain in place, fronting interior bathroom facilities 14 and 16, and 24 and 26, respectively, thereby providing privacy for the use of modern, bright, and sanitary facilities by both male and female tailgaters. Stationary wall 102 forms the entire wall of system 100 opposite the access walls 17 and 27 and stationary end walls 103 close system 100 at each end.

What is claimed is:

1. A mobile party system comprising:
a tractor unit; and
a semi-trailer having an interior wall running side to side thereby dividing the interior space of said semi-trailer into two equal halves, each such half being accessable to partygoers through a releaseable, pivotable wall situated within a side panel of said semi-trailer, and each such half being outfitted with each of following: heating, cooling, and ventilation equipment; with an electrical power source; with at least one restroom; and with kitchen and bar service facilities,
whereby dual equally proportioned areas are made available for the use of partygoers.

2. The mobile party system of claim 1 in which said heating, cooling, and ventilation equipment comprises not more than one heating unit, one cooling unit, and one ventilation unit that placed are placed in a mechanical systems area between said dual equally proportioned areas,
whereby each of said dual equivalent areas share the outputs of said heating unit, said cooling unit, and said ventilation unit.

3. The mobile party system of claim 1 in which the top of each of said releaseable, pivotable walls are connected to the roof of said semi-trailer by hinges,
whereby said walls when opened provide shelter over the entrance to each of said dual equally proportioned areas.

4. The mobile party system of claim 1 in which each of said equally proportioned areas comprises an open area, an L-shaped sitting area with seats, and counters.

5. The mobile party system of claim 1 in which said kitchen and bar facilities are comprised of an ice machine, a bar with bar stools, a sink, a stove, a microwave, and a refrigerator.

6. In a semi-trailer, the improvement comprising:
an interior wall running side to side dividing the interior space of said semi-trailer into two equal halves, each such half being accessable to partygoers through a releaseable, pivotable wall situated within a side panel of said semi-trailer, and each such half being outfitted with each of following: heating, cooling, and ventilation equipment; with an electrical power source; with at least one restroom; and with kitchen and bar service facilities,
whereby dual equally proportioned areas are made available for the use of partygoers.

7. In the improvement of claim 6, said heating, cooling, and ventilation equipment being comprised of not more than one heating unit, one cooling unit, and one ventilation unit that placed are placed in a mechanical systems area between said dual equally proportioned areas,
whereby each of said dual equivalent areas share the outputs of said heating unit, said cooling unit, and said ventilation unit.

8. In the improvement of claim 6, the top of each of said releaseable, pivotable walls being connected to the roof of said semi-trailer by hinges,
whereby said walls when opened provide shelter over the entrance to each of said dual equally proportioned areas.

9. In the improvement of claim 6, each of said equally proportioned areas being comprised of an open area, an L-shaped sitting area with seats, and counters.

10. In the improvement of claim 6, each of said kitchen and bar facilities being comprised of an ice machine, a bar with bar stools, a sink, a stove, a microwave, and a refrigerator.
